(19) United States
(12) Patent Application Publication
(10) Pub. No.: US 2019/0075947 A1
(43) Pub. Date: Mar. 14, 2019

(54) ARTICLE WITH FRAME

(71) Applicant: MEMORY HUG LLC, EFFINGHAM, IL (US)

(72) Inventor: MOLLY BUSHUE, EFFINGHAM, IL (US)

(21) Appl. No.: 15/699,021

(22) Filed: Sep. 8, 2017

(51) Int. Cl. A47G 1/16; D05B 11/00; D05B 23/00; D05C 3/00; A47G 9/02; A01K 13/00; A41D 27/08; A63H 3/52

(52) U.S. Cl. CPC A47G 1/1653; D05B 11/00; D05B 23/00; A63H 3/52; A47G 9/0223; A01K 13/006; A41D 27/08; D05C 3/00

(57) ABSTRACT

Described herein are methods and apparatus for customizing expressive content applied to an article, generally an article made from a fabric. Although the present disclosure is made with reference to quilts specifically, these are non-limiting exemplary embodiments, and the disclosure is by no means limited to quilts. The present disclosure is applicable to other arts and crafts, particularly, but not limited to, those involving the use of fabrics and similar materials.

### BACKGROUND OF THE INVENTION

### Field of the Invention

This disclosure is related to the field of apparel and fabrics, and more particularly to apparatus and methods for removably customizing an article with art or other custom content.

### Description of the Related Art

Traditional crafts have enjoyed a significant resurgence as hobbyists are relearning traditional arts, such as quilting, sewing, and embroidery. While all crafted articles are unique in some measure based on the selection and arrangement of fabric and shapes, by their nature, quilts allow for minimal granularity in the selection and arrangement of the component pieces. While simple impressions may be conveyed via a quilt by a skilled quilter, more complex or nuanced content cannot. For example, many quilters can depict ordinary objects such as a train, a football, an octopus, or even a simple landscape. However, depicting a detailed human face, or a written message, is difficult on a standard sized quilt. Additionally, enlarging a quilt to accommodate more detail often is not feasible due to material costs.

Additionally, once an article is made, it usually cannot be modified without destroying it. This can be problem because quilts and other crafts are often personalized as gifts, especially for children, based on unique characteristics of the recipient, such as nicknames and interests. However, as children outgrow nicknames, or their interests change, articles made for them when they were younger become dated, and the expressive content becomes less relevant to the child.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art described herein, among other things, is a fabric article comprising a frame attached to a first side thereof on at least one side of the frame.

In an embodiment, the frame is attached to the article of fabric on at least three sides of the frame.

In a further embodiment, the frame is attached to the article on at least four sides of the frame.

In a further embodiment, an article of visually perceptible content is disposed between the one side of the article of fabric and the attached frame.

In a further embodiment, the article is a blanket or quilt.

In a further embodiment, the article is an article of apparel.

In a further embodiment, the article of apparel is for wearing by a human.

In a further embodiment, the article of apparel is for wearing by an animal.

In a further embodiment, the article is for wearing by a toy or doll.

In a further embodiment, the frame is made from plastic.

In a further embodiment, the frame is attached to the article by embroidery.

In a further embodiment, the frame is attached to the article by sewing.

### BRIEF DESCRIPTION OF THE DRAWINGS

FIG. 1 depicts an elevational view of an embodiment of a quilt with an empty frame according to the present disclosure.

FIG. 2 depicts an embodiment of a quilt with a frame according to the present disclosure, wherein the frame contains custom content.

FIG. 3 depicts an alternative embodiment of a quilt having a plurality of empty frames.

FIG. 4 depicts a further alternative embodiment of a quilt according to the present disclosure having a plurality of frames.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein are methods and apparatus for customizing expressive content applied to an article, generally an article made from a fabric. Although the present disclosure is made with reference to quilts specifically, these are non-limiting exemplary embodiments, and the disclosure is by no means limited to quilts. The present disclosure is applicable to other arts and crafts, particularly, but not limited to, those involving the use of fabrics and similar materials.

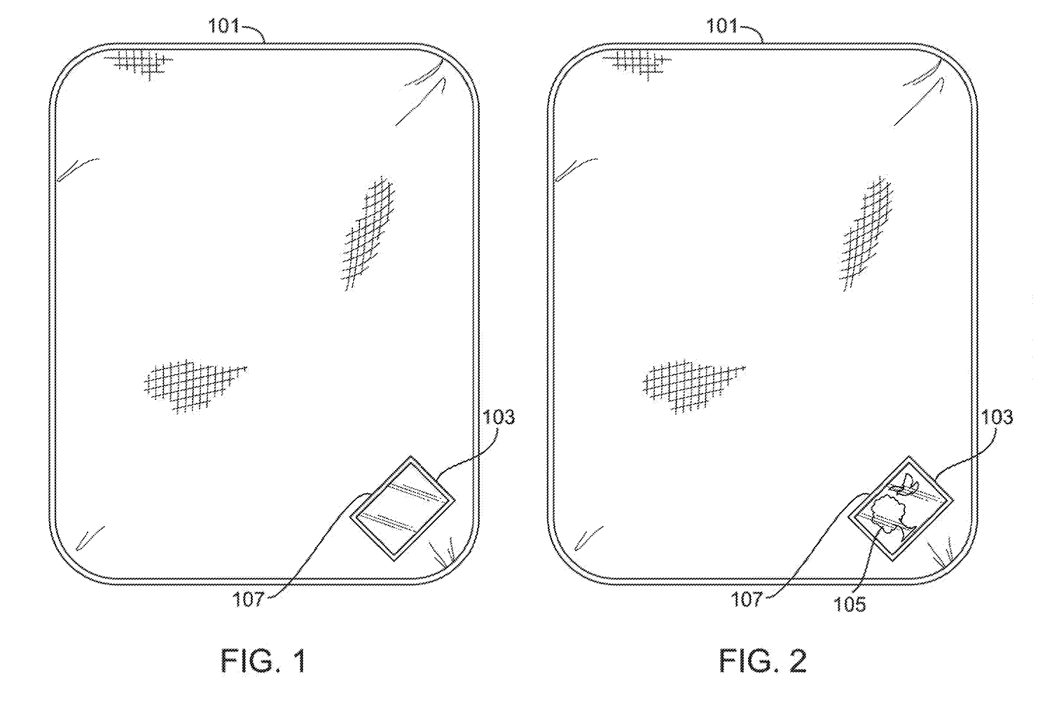

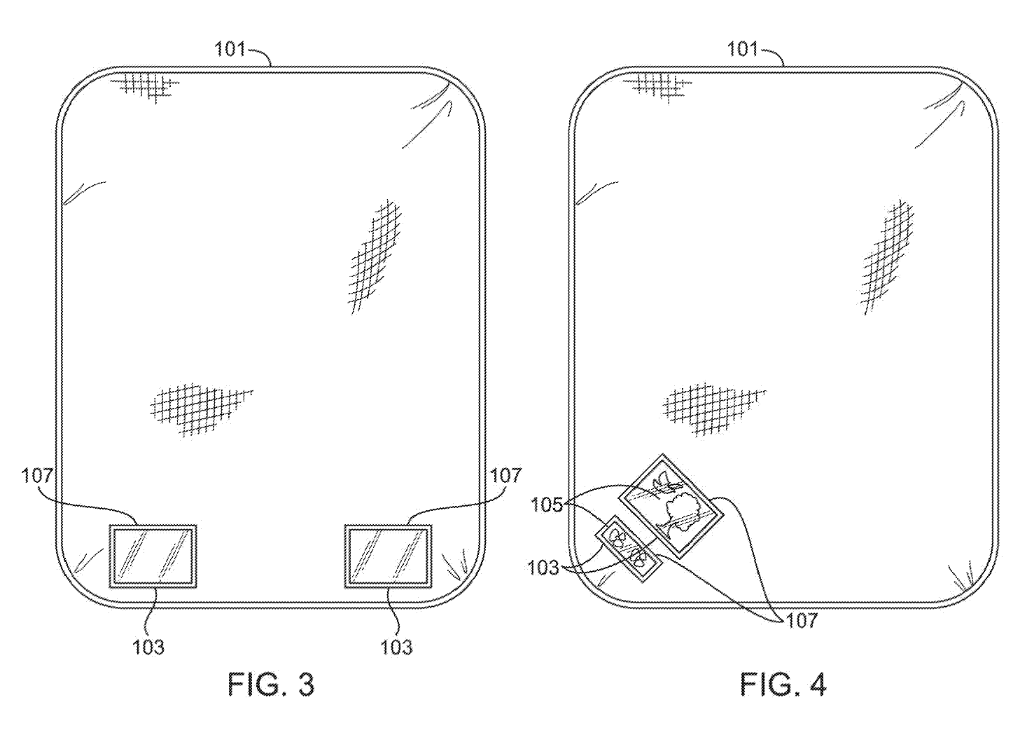

An embodiment of a quilt according to the present disclosure is depicted in FIG. 1. In the depicted embodiment, a quilt 101 is made according to known techniques, and a frame 103 is attached to a side thereof. The depicted frame 103 is a thin, clear, plastic element, but other materials and types of frames may be used. By way of example, but not limitation, a frame 103 could be made from wood, metal, fabric or other materials. Any material suitable for generally planer and flexible substrate for expressive content is appropriate. However, a soft, flexible material, such as a thin plastic, is preferred because it is less likely to scratch or irritate the user, and is easy to apply to the surface.

The frame 103 may be attached to the quilt 101 through any number of techniques. For example, in an embodiment, the frame 103 is attached to the quilt 101 through the use of an embroidery machine. A person of ordinary skill in the art will understand that this may require the development of a specific embroidery design contemplate configured to correspond to the dimensions of the frame 103. The size and shape of the frame 103 will depend upon the configuration of the particular content 105 with which the frame 103 is used. By way of example, and not limitation, if the frame 103 will hold a 4×6 inch photograph, then the dimensions of the frame 103, and by extension, the embroidery design, will correspond to a 4×6 photograph. Generally, the frame 103 is slightly larger than the content 105 in order to form a pocket 107 or other retaining means to hold the content 105 in place on the quilt 101. This larger size allows for the stitching or other attaching means to hold the frame 103 to the quilt 101 while leaving a large enough pocket 107 for the content 105.

The content 105 placed within the frame 103 may be any expressive content capable of being fixed to a substrate for insertion into the pocket 107. For example, a simple printout on a sheet of paper may be inserted, or the custom content may be a fabric iron-on or applique fabric cut to size to fit in a frame 103. Such fabric may be backed by a paperboard or other support means for easier insertion into the pocket 107. It is generally desirable that the size and shape of the frame 103, and by extension, be relatively small so that the frame 103 does not irritate the user. Thus, for a large quilt 101, the content 105, typically a small frame 103 will be attached near a corner, which then can be disposed near the feet when the quilt 101 is in use. This both reduces the likelihood that the frame 103 scratches or irritates the user, and also reduces the likelihood that ordinary use of the quilt 101 damages the content 105 or frame 103.

The actual content 105 displayed in the frame 103 will vary from embodiment to embodiment based upon preferences and taste. By way of example, and not limitation, the content 105 may be a photograph, a drawing, a poem, a quote, image, or any other visually perceptible content 105.

Although in an embodiment, the frame 103 may be effectively permanently attached to the quilt 101 by sewing, embroidering, or other attaching means for affixing the frame 103 to the quilt 101 once the content 105 is disposed between the frame 103 and quilt 101 so as to prevent the content 105 from falling loose, such as by sewing on all four sides or corners of the frame 103. However, in an alternative embodiment, at least one side or corner on the frame 103 is left open (unattached) so that the content 105 can be removed and replaced with a new or second content.

In a further embodiment, a quilt 101 may comprise one or more frames 103. Additionally, although a rectangular or orthogonal frame 103 is most common to the simplicity of the design, a frame 103 may be of any size or shape, and thus may conform to unusual or irregularly shaped content 105. In such an embodiment, attaching the frame 103 is performed in generally the same manner previously described. For example, the frame 103 may be embroidered, sewn, or quilted to the quilt 101 around the exterior or periphery of the frame 103 in some or all of the frame's 103 periphery. This may be done by hand, or with the aid of machine or device. Typically, a standard applique process may be used.

The quilt 101 may be used by the user as in the same fashion of a typical quilt 101, by drawing the quilt 101 up around the user's body for warmth or comfort. The user will generally prefer that the frame 103 elements are on the side of the blanket away from the user's body. This both prevents the frame 103 element from potentially irritating the user or snagging on clothing, and allows the user of the quilt 101 to peruse the content 105 in the frame 103 while the blanket is in use. This method may simultaneously invoke in the user a physical sense of comfort from using the quilt 101 and an emotional comfort from the meaning reflected in the content 105.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A fabric article comprising a frame attached to a first side thereof on at least one side of said frame.

2. The fabric article of claim 1 wherein said frame is attached to said fabric article on at least three sides of said frame.

3. The fabric article according to claim 1 wherein said frame is attached to said fabric, article on at least four sides of said frame.

4. The fabric article of claim 1 wherein a substrate having visually perceptible content thereon is disposed between said one side of said fabric article and said attached frame.

5. The fabric article of claim 1 wherein said fabric article is a blanket or quilt.

6. The fabric article of claim 1 wherein said fabric article is apparel.

7. The fabric article of claim 6 wherein said apparel is for wearing by a human.

8. The fabric article of claim 5 wherein said apparel is for wearing by an animal.

9. The fabric article of claim 5 wherein said apparel is for wearing by a doll or toy.

10. The fabric article of claim 1 wherein said frame is made from plastic.

11. The fabric article of claim 1 wherein said frame is attached to said fabric article by embroidery.

12. The fabric article of claim 1 wherein said frame is attached to said fabric article by sewing.

13. A method for displaying expressive content on an article comprising:
providing a fabric article;
providing a frame;
providing a substrate;
attaching said frame to said fabric article on at least one side of said frame;
inserting said substrate between said frame and said fabric article.

14. The method of claim 13 wherein said attaching step comprises attaching said frame to said fabric article on at least three sides of said frame.

15. The method article of claim 13, wherein said attaching step comprises attaching said frame to said fabric article on at least four sides of said frame.

16. The method of claim 13, wherein, said substrate comprises visually perceptible content.

17. The method of claim 13, wherein said fabric article is selected from the group consisting of: a blanket, a quilt and an item of apparel.

18. The method of claim 13, wherein said frame is made from plastic.

19. The method of claim 13, wherein said attaching comprises attaching by embroidery.

20. The method of claim 13, wherein said attaching comprises attaching by sewing.
